(19) United States
(12) Patent Application Publication
(10) Pub. No.: US 2008/0151368 A1
(43) Pub. Date: Jun. 26, 2008

(54) Led-Module Used for Illumination in a Microscope

(75) Inventor: Albrecht Weiss, Linden (DE)

Correspondence Address: FOLEY AND LARDNER LLP;SUITE 500, 3000 K STREET NW, WASHINGTON, DC, 20007, US

(73) Assignee: Leica Microsystems CMS GmbH

(21) Appl. No.: 11/815,292

(22) PCT Filed: Jan. 10, 2006
(86) PCT No.: PCT/EP06/50113

§ 371 Date: Aug. 1, 2007

(30) Foreign Application Priority Data
Feb. 8, 2005 (DE) 10 2005 005 618.0

(51) Int. Cl. G02B 21/06

(52) U.S. Cl. 359/390

(57) ABSTRACT

The invention relates to an LED module (60) which is configured in such a manner that in can be used in a conventional base (47) for a conventional light source without the need to change the circuitry of the microscope. The functionality of the LED module (60) is guaranteed by the mere insertion of the module into the base (47).

The invention relates to an LED module used for illumination in a microscope.

U.S. Pat. No. 6,327,102 discloses a miniature microscope suitable for a vacuum. An illumination device is integrated in the microscope camera, which is based on a CCD. An LED is placed a lateral opening of the objective in order to make illumination available for the object. The patent does not mention that the diode also be exchanged for a conventional low voltage illumination source.

U.S. Pat. No. 6,313,943 describes an underwater microscope. The LED light source is arranged in a circle around the optical axis of the optical system of the camera. The LED illumination source emits light synchronously with a video signal from the camera. An LED module is not proposed here for exchange.

German patent application DE 100 17 823 A1 discloses a microscopic illumination device in which the light source is formed by an LED arrangement. The light source is an LED array that consists of a plurality of preferably identical LEDs that are arranged tightly packed in concentric rings and thus cover a circular surface. There is no provision to be able to exchange the LED arrangement for a conventional light source.

European patent specification EP 1 331 504 B1 discloses an illumination device for microscopes that is equipped with at least one electrical light source such as an incandescent lamp, a neon lamp, an LED or the like. The light source is arranged in a housing that extends in a U-shaped fashion around an objective of the microscope. This device is not suitable for exchange against a conventional lamp provided for the microscope illumination.

German laid-open patent application DE 37 34 691 A1 discloses an illumination device for microscopes in the case of which the conventional light source is replaced by a semiconductor light source. The basic design of the illumination system constitutes a so-called Köhler system. This system uses a surface light source comprising a semiconductor light source, for example an LED or laser diode, instead of the customary halogen lamp. Exchangeability of the LEDs against a conventional light source in order thereby also to use the power supply of a conventional light source is not disclosed here.

German laid-open patent application DE 103 14 125 A1 discloses an arrangement for illuminating objects with light of a different wavelength. To this end, a receiving device is provided that can rotate about an axis of rotation and has holders for in each case at least one LED. The receiving device is arranged in a housing that can be mounted on the instrument housing (microscope) or is arranged positioned in the instrument housing. A drive device for the defined setting of the receiving device is provided in such a way that the LED with the centroid wavelength respectively required for measurement and/or observation can be positioned in front of a light exit opening of the housing. An exchangeability of the LED illumination against a conventional illumination is not disclosed by this specification.

German laid-open patent application DE 198 45 603 A1 discloses an illumination device for a microscope. A first light source, an illumination lens, an aperture stop and a condenser head are arranged in the illumination beam path. The illumination light is directed onto the object plane through the aperture stop via the condenser head. Also arranged in the illumination beam path on the optical axis is a second light source that is imaged to infinity by the condenser head. Only that geometric light flux that is used by the appropriate objective is produced by the arrangement of the two light sources, which are designed as LEDs. It is thereby possible to dispense with the high-performance halogen lamps previously used. An arbitrary exchangeability of the LEDs against the halogen light sources is not provided here.

US patent application 2004/0027658 A1 discloses an illumination system for a microscope. An LED light source is provided in the optical beam path, being arranged below the microscope stage. A part of the basic body of the microscope has a plate that can be removed or swung out in order thereby to exchange the used batteries or the used LED. An exchange of the LED against a conventional light source is not provided here and also cannot be ensured by the electronic circuit.

The object of the invention is to provide an LED module that can be exchanged against a conventional halogen light source of a microscope without additional design outlay.

The practical object is achieved by an LED module used for illumination in a microscope and that has the features of patent claim 1.

The invention has the advantage that the LED module is provided with two connecting pins for the power supply that fit into a lamp base of a conventional halogen lamp. The LED module comprises a support on which the two connecting pins are attached. At least one LED, a bridge rectifier and a series resistor are arranged on the support. The connecting pins are configured in such a way and arranged on the support of the LED module in such a way that the at least one LED is located at the position of the incandescent bulb when the LED module is inserted into the lamp base of the microscope.

The LED provided on the LED module is a single LED that emits white light. In accordance with another embodiment, it is likewise conceivable that the several LEDs provided on the LED module constitute an LED arrangement that emits white light in its entirety. Provided on the support of the LED module is a bridge rectifier that ensures the correct polarity of the at least one LED and, in so doing, uses both half-waves from the AC line components. Likewise, a series resistor is provided on the support of the LED module such that the maximum permissible current of the at least one LED is not exceeded at maximum operating voltage. The lamp base is attached on a slide that can be inserted from outside into a stand of the microscope and can be removed from the stand of the microscope. A receptacle for the slide is provided in the stand of the microscope and ensures a connection for a plug formed on the slide. With the slide pushed into the microscope, the power supply to the lamp base and to the two connecting pins of the support is then ensured.

Further advantageous refinements of the invention can be gathered from the subclaims.

The subject matter of the invention is illustrated schematically in the drawing and will be described below with the aid of the figures, in which:

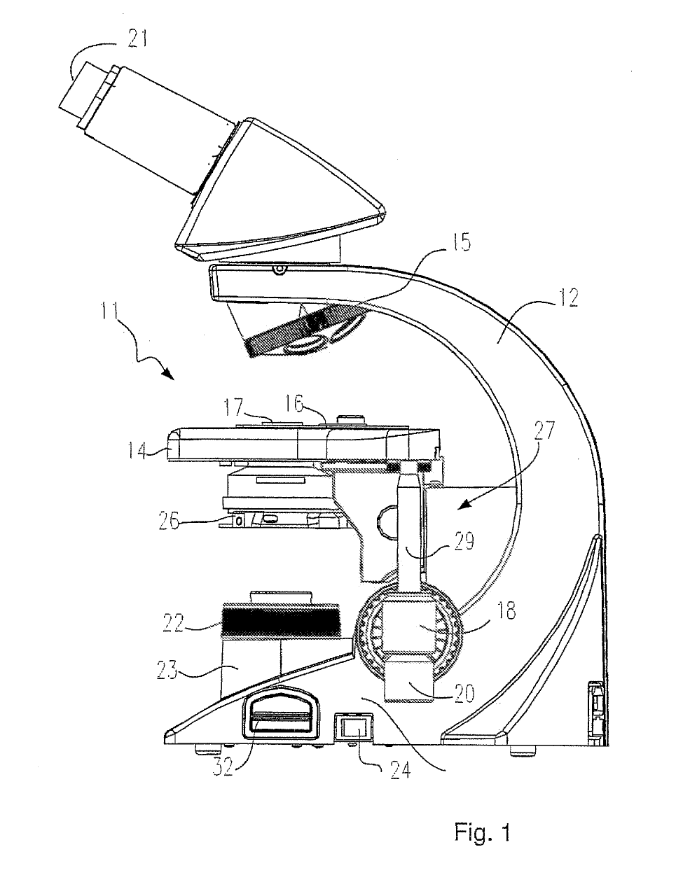

FIG. 1 shows a side view of the microscope, which comprises the inventive LED module used for illumination;

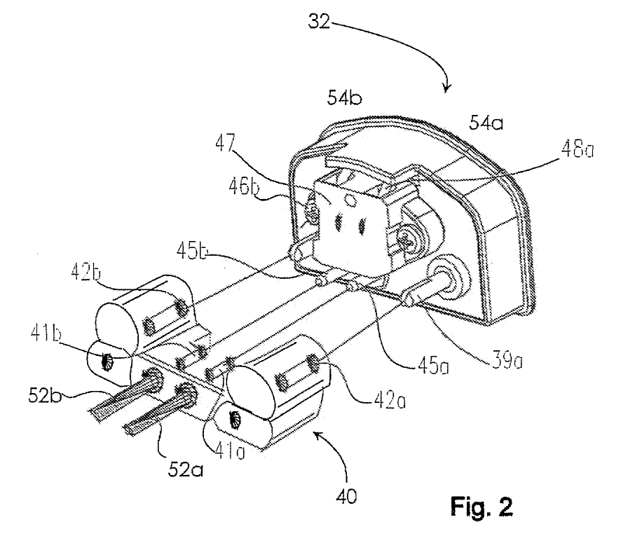

FIG. 2 shows a perspective view of the interaction of the receptacle and the slide in order to produce an electrical connection for the lamp base arranged in the slide;

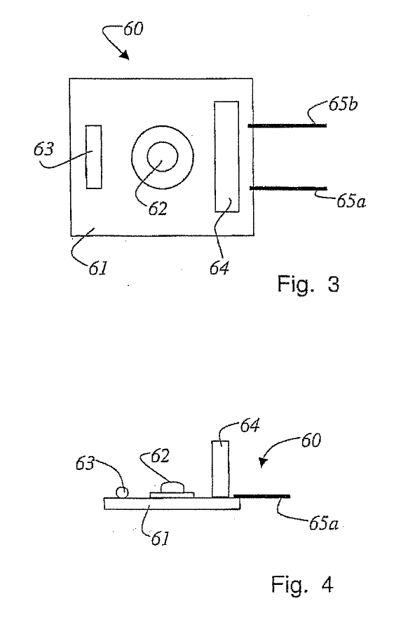

FIG. 3 shows a schematic plan view of the inventive LED module; and

FIG. 4 shows a side view of the inventive LED module.

FIG. 1 shows a side view of an upright microscope in the case of which the present invention is used. The microscope comprises a stand 12 on which all the components of the microscope are fastened. Provided on the top side of the stand 12 is a binocular eyepiece 21 for viewing a specimen slide 17 laid on the microscope stage 14. The specimen slide 17 is inserted into a specimen slide holder 16. A revolver 15 is likewise attached on the upper part of the stand 12. The microscope further comprises an exchangeable microscope stage drive system 11 that is likewise fastened on the stand 12. The exchangeable microscope stage drive system 11 likewise comprises a drive mechanism 27. The microscope stage 14 can be moved appropriately via a drive mechanism 29 that has an operating knob for the X-direction 18 and an operating knob for the Y-direction 20. A condenser arrangement 26 is provided below the microscope stage 14. A luminous field stop arrangement 22 is provided on the lower part 28 of the stand 12. The condenser arrangement 26 defines an illumination axis p. Provided in a side wall 31 of the stand 12 is a slide 32 that supports a light source (not illustrated). Likewise provided on the side wall 31 of the stand 12 of the microscope is a switch 24, with the aid of which it is possible, for example, to switch on the power supply for the light source.

FIG. 2 shows an exploded illustration of the interaction of the receptacle 40 and the slide 32. The slide 33 comprises two aligning pins 39a and 39b that fit into two corresponding suction holes 42a and 42b on the receptacle 40. Likewise provided on the slide 32 are two electrical contacts 45a and 45b that fit into two corresponding electrical contacts 41a and 41b on the receptacle 40. The electrical contacts 412a, 41b are likewise designed as suction holes. The power supply to the receptacle 40 is ensured via the lines 42a and 42b. The lamp base 47 is fastened in the slide 32 with the aid of two screws 46a and 46b. The lamp base 47 has two openings 54a and 54b into which connecting pins of a lamp can be inserted in order thereby to produce the power connection for the lamp.

FIG. 3 illustrates a plan view of the inventive LED module 60 of the present invention. The LED module 60 has a support 61 on which the at least one LED 62, a series resistor 63 and a bridge rectifier 64 are arranged. Connected to the support 61 are two connecting pins 65a, 65b. The two connecting pins 65a and 65b have a configuration such that they can be inserted into the lamp base 74 for a conventional halogen light lamp.

The LED module 60 is illustrated in side view in FIG. 4. The support 61 is designed as a plate on which the already mentioned elements such as, for example, the LED 62, series resistor 63 and bridge rectifier 64 are arranged. The connecting pins 65a, 65b are provided on the support 61 in such a way that the light-emitting diode 62 is positioned at the site of a luminous filament of a conventional halogen lamp when the LED module 60 is inserted into the lamp base 47 of a microscope. It is preferred to use as LED 62 a single white, high-performance light-emitting diode such as, for example, of Luxeon type. It is likewise conceivable to arrange on the LED module 60 a number of light-emitting diodes that can respectively emit light of different wavelengths and in so doing can also attain white light by mixing light. The bridge rectifier 64 provided on the LED module 60 ensures that the polarity of the voltage supplied to the LED 62 is correct. Both half-waves are used in the case of AC line components.

The series resistor 63 on the LED module 60 is designed in such a way that the maximum permissible current for the LED 62 (or the several LEDs) is not exceeded at maximum voltage present at the microscope. If an LED of Luxeon type is used, the maximum current is, for example, 350 milliamperes for a 1 watt Luxeon LED.

1. An LED module used for illumination in a microscope, wherein the LED module is provided with two connecting pins for the power supply that fit into a lamp base of a conventional halogen lamp.

2. The LED module as claimed in claim 1, in which the LED module comprises a support on which the two connecting pins are led away, and in which at least one LED, a bridge rectifier and a series resistor are arranged on the support.

3. The LED module as claimed in claim 1, in which the support and the connecting pins are configured in such a way that the at least one LED is located at the position of the incandescent filament when the LED module is inserted into the lamp base.

4. The LED module as claimed in claim 2, in which the LED provided on the LED module is a single LED that emits white light.

5. The LED module as claimed in claim 1, in which several LEDs provided on the LED module constitute an LED arrangement that emits white light in its entirety.

6. The LED module as claimed in claim 2, in which there is provided on the support a bridge rectifier that ensures the correct polarity of the at least one LED and, in so doing, uses both half-waves from the AC line components.

7. The LED module as claimed in claim 2, in which a series resistor is provided on the support such that the maximum permissible current of the at least one LED is not exceeded at maximum operating voltage.

8. The LED module as claimed in claim 1, in which the lamp base is led away from a slide that can be inserted from outside into a stand of the microscope and can be removed from the stand of the microscope.

9. The LED module as claimed in claim 8, in which a receptacle for the slide makes available in the microscope a connection for a plug formed on the slide, in order to ensure the power supply to the lamp base and to the two connecting pins of the support with the slide pushed into the microscope.
